(19) United States
(12) Patent Application Publication
(10) Pub. No.: US 2022/0315671 A1
(43) Pub. Date: Oct. 6, 2022

(54) PRODUCT OF CRYSTALLINE STARCH NANO-MICROPARTICLES, PROCEDURES AND GEL FOR VARIOUS APPLICATIONS

(71) Applicants: Javier De Torres, La Lucila (AR); UNIVERSIDAD DE BUENOS AIRES, Buenos Aires (AR); CONSEJO NACIONAL DE INVESTIGACIONES CIENTIFICASY TÉCNICAS CONICET, BuenosAires (AR)

(72) Inventors: Silvia Nair Goyanes, Buenos Aires (AR); Gerardo Héctor Rubiolo, Buenos Aires (AR); Norma Beatriz D'accorso, Buenos Aires (AR); Lucía Mercedes Famá, Buenos Aires (AR); Paula Fabiana Gonzalez Seligra, Buenos Aires (AR)

(73) Assignees: Javier De Torres, La Lucila (AR); UNIVERSIDAD DE BUENOS AIRES, Buenos Aires (AR); CONSEJO NACIONAL DE INVESTIGACIONES CIENTIFICASY TÉCNICAS CONICET, BuenosAires (AR)

(21) Appl. No.: 17/658,241

(22) Filed: Apr. 6, 2022

Related U.S. Application Data
(60) Provisional application No. 63/171,439, filed on Apr. 6, 2021.

(51) Int. Cl. C08B 30/06; C08B 30/02

(52) U.S. Cl. CPC C08B 30/06; C08B 30/02; B82Y 40/00

(57) ABSTRACT

Crystalline starch nano-microparticle product, gels and procedures are disclosed, wherein the nano-microparticle product comprises between 60% and 70% crystalline nano-microparticles and between 40% and 30% modified starch grains, wherein at least 90% of the nano-microparticles have sizes less than 200 nm and more than 40% of said nano-microparticles are less than 100 nm. The nano-microparticles can be mixed with boiling water, giving rise to gels that are useful in coating food, making creams and other uses, including the controlled release of different compounds.

### FIELD OF THE INVENTION

The present invention relates to a crystalline starch nano-microparticle product, gels and procedures. More particularly, it refers to a nano-microparticle product comprising between 60% and 70% of crystalline nano-microparticles and between 40% and 30% of modified starch grains, wherein at least 90% of the nano-microparticles have sizes less than 200 nm and more than 40% of said nano-microparticles are less than 100 nm. The nano-microparticles can be mixed with boiling water, giving rise to gels that are useful in coating food, making creams and other uses.

### BACKGROUND

In the food industry, attempts are being made to implement more natural products that are cheap and easy to assimilate by the consumer. In this sense, it is beginning with the use of products that are within the framework of nanotechnology.

Methods for preparing starch nanoparticles using enzymes and starch recrystallization are known (CN102964609).

Methods for preparing starch nanoparticles by acid hydrolysis are known, which lead to crystalline nanoparticles, with sizes between 15-40 nm (Le Corre D., Bras J., & Dufresne A. (2010) Starch Nanoparticles: A Review. Biomacromolecules, 11, 1139-1153). It has the disadvantage of low performance. Even under the optimal conditions to produce nanoparticles with acid hydrolysis, a yield of 14.69% is obtained (Park E. Y., Kim M., Cho M., Lee J. H. & Kim, J. (2016) Production of starch nanoparticles using normal maize starch via heat-moisture treatment under mildly acidic conditions and homogenization. Carbohydrate Polymers, 151, 274-282).

Homogenization and emulsion methods are known (Ding Y., Zheng, J., Zhang, F., & Kan, J. (2016), Synthesis and characterization of retrograded starch nanoparticles through homogenization and miniemulsion cross-linking. Carbohydrate Polymers, 151, 656-665 and Chin S F, Azman, A., & Pang, S C (2014). Size controlled synthesis of starch nanoparticles by a microemulsion method. Journal of Nanomaterials, 9, 1-7).

Reactive extrusion methods are known (Song, D., Thio, Y. S., & Deng, Y. (2011). Starch nanoparticle formation via reactive extrusion and related mechanism study. Carbohydrate Polymers, 85(1), 208-214).

Ultrasound methods are known. Ultrasound breaks the crystalline structure of starch, leading to nanoparticles with low crystallinity or an amorphous structure with sizes between 30 nm and 100 nm. (Kim H. Y., Park S. S. & Lim S. T., (2015) Preparation, characterization and utilization of starch nanoparticles. Colloids and Surfaces B: Biointerfaces, 126, 607-620 and Haaj, S. B., Magnin, A., Pétrier, C., & Boufi, S. (2013). Starch nanoparticles formation via high power ultrasonication. Carbohydrate Polymers, 92(2), 1625-1632).

### BRIEF DESCRIPTION OF THE INVENTION

A crystalline starch nano-microparticle product is provided comprising between 60% and 70% crystalline nano-microparticles and between 40% and 30% modified starch grains. Where at least 90% of the nano-microparticles have sizes less than 200 nm and more than 40% of said nano-microparticles are less than 100 nm.

A procedure is provided for obtaining a product of crystalline starch nano-microparticles, with a content of between 60% and 70% of crystalline nano-microparticles and around 40% and 30% of modified starch grains and wherein at least 90% of the nano-microparticles are smaller than 200 nm and more than 40% of these nano-microparticles are smaller than 100 nm. The procedure comprises the following steps: preparing an aqueous solution of starch:water at a ratio between 1:99 and 10:90 and stirring and then heat it to a temperature between 50° C. and 60° C. maintaining constant stirring. Subsequently, the solution is cooled to a temperature between 4° C. and 6° C., washed with distilled water and a wet paste is obtained that comprises a starch/water ratio of around 50/50 and is irradiated at a dose of between 20 kGy and 23 kGy; to finally freeze-dry said paste if necessary. In one embodiment the water for preparing the aqueous solution may be water at an acidic pH, for example a pH of 4.5.

A starch gel is provided that comprises between 1% and 20% of the product of the nano-microparticles and between 99% and 80% of water, depending on its subsequent use, for example for coating foods such as fruits or for the preparation of creams. The gel can be lyophilized for other uses, for example in the pharmaceutical industry.

### BRIEF DESCRIPTION OF THE FIGURES

FIG. 1 shows a photograph of the supernatants of the system without potassium sorbate (K-sorb) after the washes, complexed with a 2% iodine solution.

FIG. 2 shows the absorption spectra of the supernatants (with and without potassium sorbate) after each wash.

FIG. 3 shows photographs of the nano-microparticles without sorbate.

FIG. 4 shows images of the nano-microparticles without and with sorbate (A and B, respectively) taken by optical microscopy with polarizers.

FIG. 5 shows SEM micrographs of the nano-microparticles obtained at different magnifications: (A) and (B) starch grains modified by irradiation (1 KX); (C), (D), (E) and (F) nanoparticles (50 KX and 200 KX).

FIG. 6 shows SEM micrographs of the nanoparticles detaching from the starch grain: (A) and (B) nanoparticles (25 KX and 50 KX).

FIG. 7 shows the histogram of the size distribution of the nano-microparticles without potassium sorbate, from the SEM micrographs.

FIG. 8 shows the results of the size distribution of the nano-microparticles without potassium sorbate, from the DLS tests.

FIG. 9 shows the X-ray diffraction results of the starch nano-microparticles without K-sorb (a) and with K-sorb (b), and of the native starch (c).

FIG. 10 shows the results of the thermal properties of the nano-microparticles and native starch by thermogravimetric analysis (TGA).

FIG. 11 shows photographic images of a split apple (A and B) and a potato (C and B), where one half (the right) contains the nano-microparticle gel of the present invention. Photos A) and C) represent the immediate moment after placing the gel. Photos B) and D) were taken after 48 hours of storage.

FIG. 12 shows photographic images of the gel immediately when it reaches room temperature where a certain viscosity is seen that represents mobility (A) and after half an hour, poured into a Petri dish, where a gelatin (product without mobility) is seen (B), both for 7% of particles; and (C) gel with 20% nano-microparticles after passing overnight after approximately 12 hours).

FIG. 13 shows photographic images of the gelled and lyophilized material.

FIG. 14 shows SEM micrographs of the gelled and lyophilized material.

FIG. 15 shows a controlled release curve at different pH.

FIG. 16 shows the preparation of a film by dehydration of the starch nano-microparticle gel of the present invention. The nano-microparticle gel is poured into a Petri dish (A), once the desired thickness is achieved in the Petri dish (B), the gel is allowed to dehydrate at room temperature in a desiccator, and then the formed film is separated from the Petri dish (C).

### DETAILED DESCRIPTION OF THE INVENTION

In a preferred embodiment of the procedure of the present invention, gamma irradiation is carried out on a wet paste comprising a starch/water ratio of at least 50/50. This relationship generates a high yield of the final product.

The procedure of the invention makes it possible to obtain a product made up of nano-microparticles and treated starch grains (fragmented, with holes). A crystalline product is obtained.

In the procedure of the invention it is not necessary to carry out re-crystallization steps because a crystalline material is irradiated and another crystalline material is obtained. When carrying out a first stage of heating the product to a maximum temperature of 50° C., the product obtained is crystalline, directly irradiating a wet paste of crystalline starch, wherein part of the product is nano-microparticles and another part is grains of treated starch (fragmented, with holes).

Basically, the procedure consists of a low-temperature heat treatment of a mixture of starch and water, subsequent washing, removal of water either by decantation, centrifugation or filtration, and subsequent treatment of the obtained paste with gamma radiation at a dose between 15 kGy and 25 kGy. One of the advantages of the procedure consists in the high yield (at least 600 grams of product is obtained for every 1000 grams of starch; preferably at least 700 g).

Starch was transformed, by an irradiation process, into crystalline starch nano-microparticles with about 65% submicron size and about 35% micron size. From the point of view of the product that results from this process, it consists of a nano-microparticle/starch grain mixture modified in size, composition and structure with different characteristics from the product obtained by other techniques. A product is obtained wherein at least 90% of the nano-microparticles have sizes less than 200 nm and of these, more than 40% are less than 100 nm. This product has advantages over having only nanoparticles or one made by mixing nanoparticles with starch grains. These advantages are, for example, the ability to generate non-sticky gels with a consistency similar to jelly; and if these gels are lyophilized, they lead to a unique micro-nano-porous structure of ultralight solid material, capable of storing different active ingredients inside.

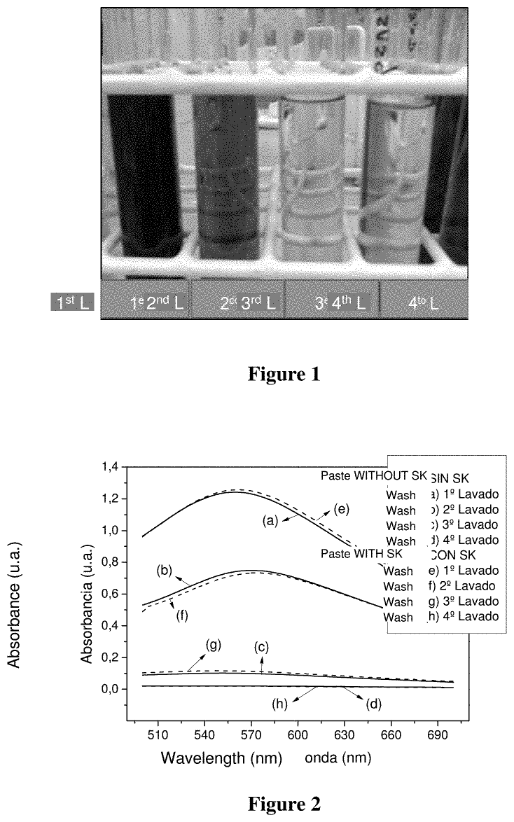

Evaluation of the amylose content resulting from the leftovers from each wash (without sorbate), prior to irradiation: the results are shown in FIG. 1, where the number of washes is specified from left to right (1st wash, 2nd wash, 3rd wash, 4th wash, respectively).

The 2% iodine solution consists of polyiodide ions of the In⁻ type and has a yellowish-brown color. In the presence of starch, iodine is introduced into the helical chain conformations of amylose, leading to the formation of an iodine-amylose complex. This complex absorbs light at a different wavelength than the In⁻ ions, displaying a dark blue color. The intensity of the blue color decreases with the decrease in the number of complexes formed.

As can be seen in FIG. 1, after the first wash, the paste solution with the iodine complex had a dark blue color. This shade of blue color gradually became lighter as the paste was successively washed, until reaching the last wash (the 4th) with a yellow color. This variation in hue indicates a reduction in the amount of complexes formed. Since the same iodine solution (2%) was used for all the aliquots of the different washes, this reduction in the number of iodine-amylose complexes was a consequence of the decrease in the amount of amylose in the paste. From these results it was possible to establish that after the fourth wash, there is no significant presence of amylose.

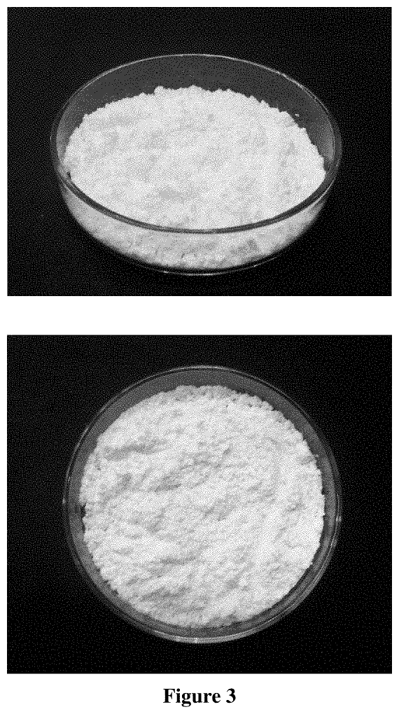

A quantitative analysis was performed to find out the contents of amylose after each wash, by colorimetric determination, using UV-Visible spectroscopy. The results are shown in FIG. 2. It is observed that the supernatants obtained from both pastes (with or without potassium sorbate) do not show significant differences in the intensity of the peak; and that after the fourth wash the absorbance is less than 0.1, being the one with the lowest content of amylose present.

It should be noted that the results of the supernatants in the different kinds of pastes (with or without potassium sorbate) did not show significant changes; showed that the addition of about 0.2% by weight of this antimicrobial agent did not modify the structure or the crystallinity of the nano-microparticles.

FIG. 3 shows the photos of the lyophilized starch nano-microparticles obtained at the end of the procedure.

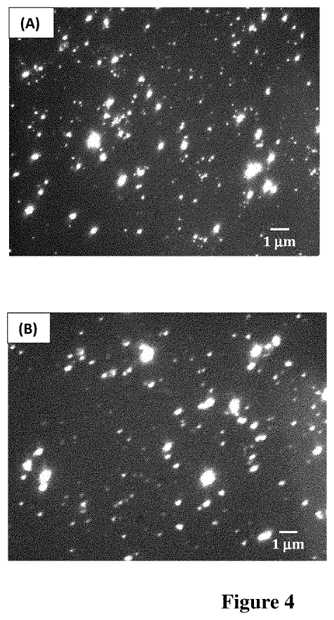

Observations by Optical Microscopy with polarized light: FIG. 4 (A and B) shows the images by optical microscopy with crossed polarizers of the nano-microparticles without and with potassium sorbate. These photos were taken in order to observe the typical birefringence that forms in crystalline starch particles (light and dark, due to the double deflection of the light beam). Birefringence was observed in both materials, showing that the nano-microparticles are crystalline and not amorphous.

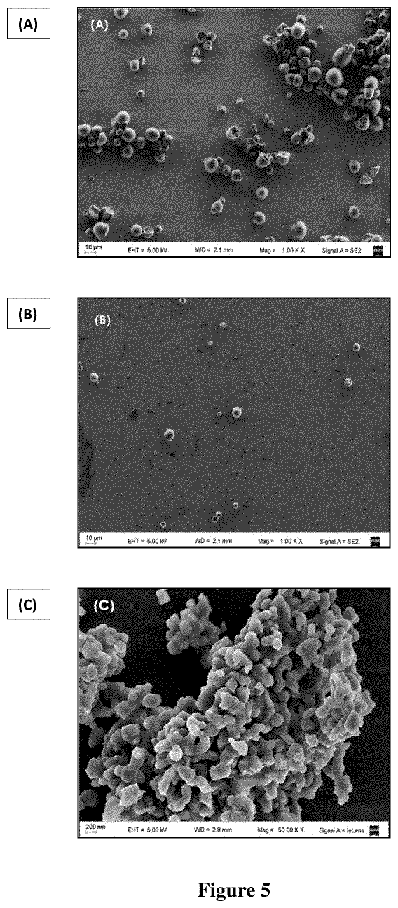

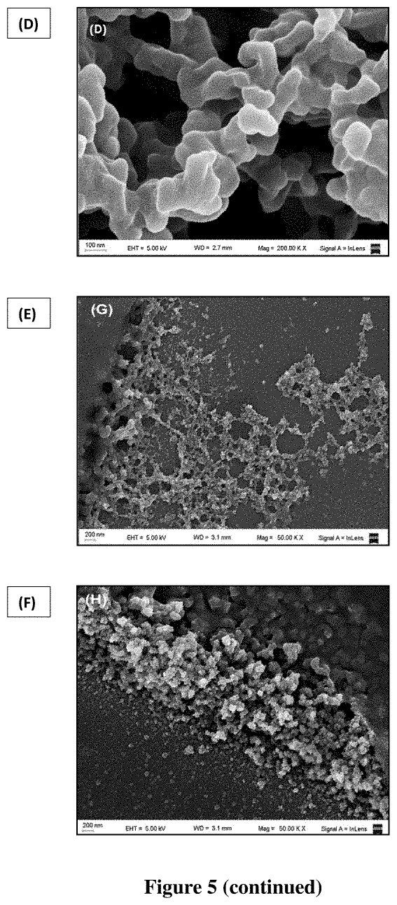

Evaluation of the morphology of the nano-microparticles: FIG. 5 shows the SEM images of the particles obtained by gamma radiation. In FIGS. 5A and 5B, the micro and nanometric size particles obtained by gamma radiation of the systems without and with K-sorb, respectively, are shown. The grains modified by the irradiation process were characterized by dark areas in their centers, indicating regions of lower density that were strongly affected by gamma radiation. There is no effect on morphology or size distribution due to the addition of potassium sorbate.

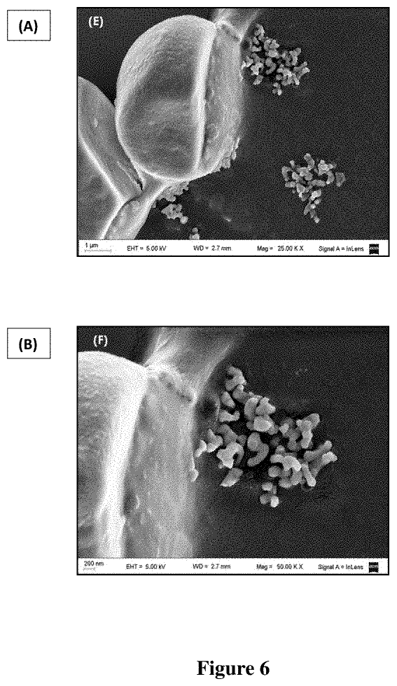

On the other hand, it can be seen that the nanometric-sized particles were associated forming a grape-like structure (systems without K-sorb: FIGS. 5C, 5D and 5E, systems with K-sorb: FIG. 5F). It is known that starch nanoparticles have a high tendency to strongly associate with each other through hydrogen bridge bonds, as a consequence of the high density of OH groups (inherent in any polysaccharide material) present on the surface of each nanoparticle. In the images corresponding to FIGS. 6A and 6B, the mechanism of formation of the nanoparticles is visualized, which are “detaching” from the grain of starch affected by gamma radiation.

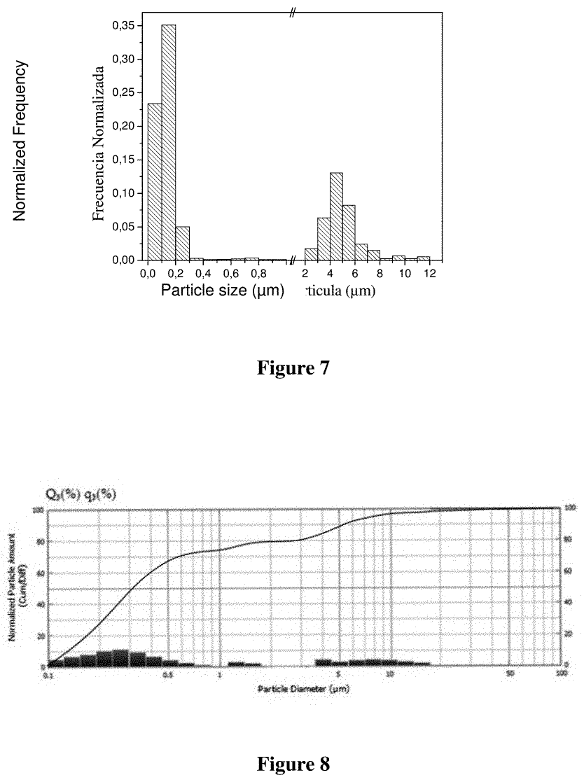

Determination of particle size from the SEM micrographs: the histogram representing the size distribution of the nano-microparticles obtained by gamma radiation was made from the calculation of the particle diameter taken from the SEM images (FIG. 7). Due to the manufacturing process of the material, the treated grains have a wide size distribution.

From the image analysis it was possible to determine that a material composed of at least 65% of submicron particles and around 35% of starch grains modified by the irradiation process was obtained. In addition, at least 90% of the submicron particles were smaller than 200 nm, of which more than 45% were smaller than 100 nm (nanoparticles).

Determination of particle size from DLS (Dynamic Light Scattering) studies: FIG. 8 shows the results of the DLS tests for the particles. It can be seen that the distribution does not change significantly with respect to the histograms shown in FIG. 7.

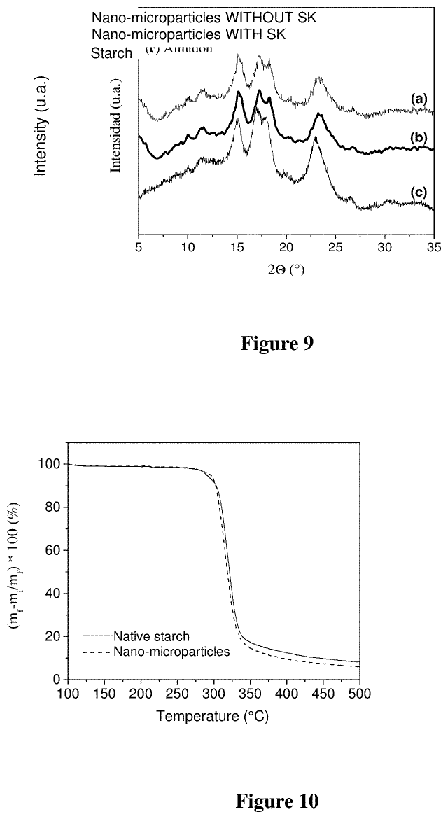

Evaluation of the crystallinity of the nano-microparticles: in order to analyze the crystallinity of the materials obtained by gamma radiation (with and without K-sorb), X-ray diffraction tests were performed and compared with the pattern obtained for native starch (see FIG. 9).

No effects were observed with the addition of sorbate, FIG. 9 shows the obtained curves, (curve (b) versus curve (a)). The nano-microstructured materials presented a diffraction pattern similar to that of the native starch grain (curve (c)), indicating that gamma radiation affects the amorphous zones.

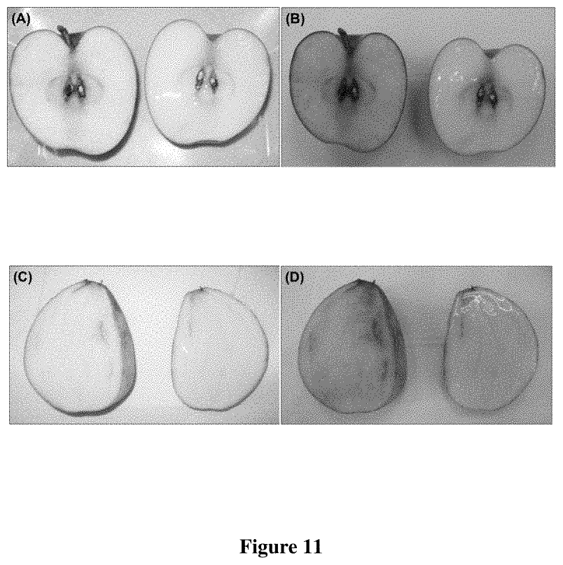

Evaluation of the thermal properties of the nano-microparticles: FIG. 10 shows the curves obtained from thermogravimetric tests (TGA) of the nano-microparticles and native starch. These tests were carried out in order to determine the thermal degradation of the materials. The nano-microparticles maintained the thermal stability of the native starch, being thermally stable up to a temperature around 275° C. This means that the gamma radiation process does not modify the thermal degradation temperature of the material. Therefore, the nano-microparticles can be used under the same thermal conditions as native starch without suffering any type of temperature degradation. This is very important from the point of view of the application of the particles because as they do not degrade with temperature, for example if they are cooked up to around 275° C., there is no change in the final product.

Gels and Gelified and Lyophilized Products:

With nano-microparticles, gels can be generated in a simple way. Said gels can be applied by means of different techniques on food products for their preservation.

FIG. 11 shows photos of different products (apple and potato), as an example, where one half is covered with the nano-microparticle gel and the other half is uncoated. The behavior throughout the storage of the products in relative humidity of 57% is observed. Storage 48 hours.

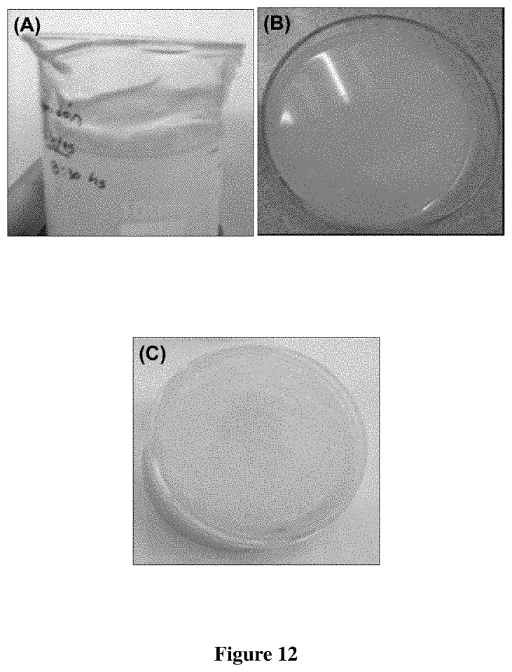

In addition, gelled products can be generated from the immersion of between 1% and 20% of nano-microparticles in boiling water, such that, immediately upon reaching room temperature, a gel is generated that is in a viscous state with movement (it can flow) (FIG. 12A), and that after approximately 30 min, it turns into jelly (FIG. 12B). FIGS. 12A and 12B show the case of a gel made up of 7% of the particles, while FIG. 12C shows one with 20%, the maximum value that generates a thicker cream-like gel, after 12 hours. This last gel could be used in cosmetics, for example, or in foods to incorporate into sausages as a replacement for flour, but in much smaller quantities.

On the other hand, in the food industry it can replace the applications of starch as a thickener, with the advantage that at least 65%, being submicron in size, can be more easily digested.

The incorporation of essential oils in a starch gel and in the gel of starch nano-microparticles has been tested. Fragrance retention of limonene essential oil was determined both in the gel formed by the nano-microparticles, and in a native cassava starch gel, by means of GC-MS (gas chromatograph with a mass selector) studies. Measurements were made after 1 month by opening the vials containing the gels twice a day, every day, and leaving them open for 5 minutes. The sample made with starch after 4 days of study did not measure a fragrance peak related to the essential oil, while the nano-microparticle gel maintained its 75% fragrance.

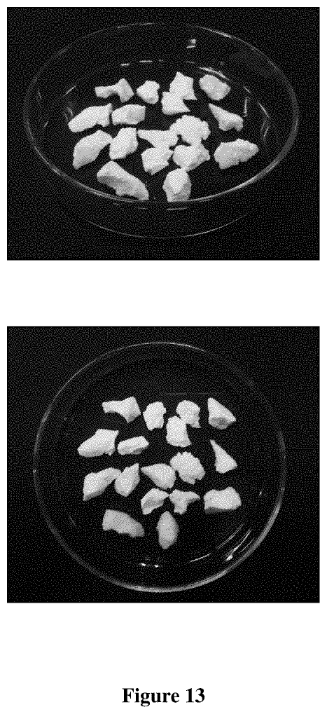

Products whose photographic images are shown in FIG. 13 can be obtained from the gels of the invention by lyophilization. The products are highly porous and have low density.

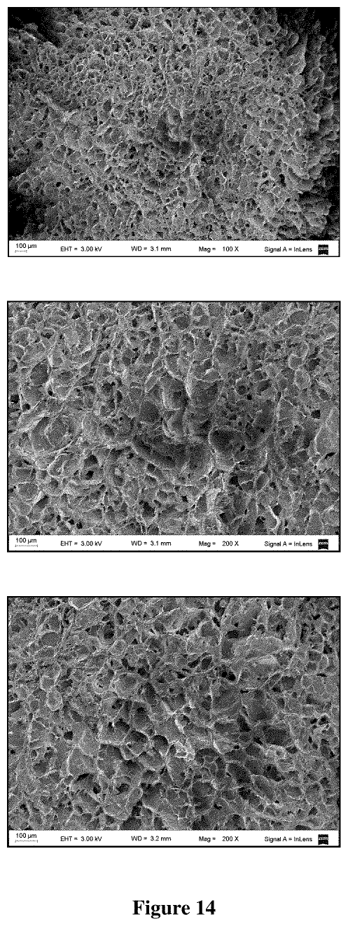

FIG. 14 presents the SEM images of these gelled and lyophilized products, where the porous structure is clearly observed.

In the pharmaceutical, cosmetic and agronomic industries, the product can be used since prior gelation and lyophilization of the same, leads to highly porous, ultralight and natural structures that can contain antibiotics, vitamins, antioxidants, fertilizers or the additive that one wishes, controlling the release. In addition, thanks to its highly porous structure, the product could replace styrofoam or the material traditionally used in packaging, with the additional advantage that this material is biodegradable and would not lead to polluting waste.

In the packaging industry, it could replace starch-containing containers with the additional advantages of its high crystallinity.

This process could be extended to any polysaccharide from gamma radiation cleavage of the O-glycosidic bond.

The product can be colored with pigments and/or natural inks. In addition, it can be derivatized or modified with different substances intended for a particular use thanks to the high density of hydroxyl groups that the material presents on the surface. This same effect makes the material a powerful water absorber, for which it could be used to replace previously known moisture absorbers.

It is a product considered by European legislation as natural nanoparticles. The material is non-toxic, edible, non-irritable. This is because the body is used to processing starch and as part of this process it breaks down into nanoparticles. In addition, in the case of using cassava starch as the starting starch, the product would be suitable for coeliacs. Nanoparticle legislation considers as such a particle with a size less than or equal to 100 nm.

The density of the pieces has been determined by measuring their geometry and weight. From statistics of more than 10 samples, the density of the irradiated and lyophilized gel was determined to be 0.17 g/cm³±0.02 g/cm³. This invention is better illustrated according to the following examples, which should not be interpreted as a limitation imposed on the scope thereof. On the contrary, it should be clearly understood that other embodiments, modifications and equivalents thereof may be resorted to, which after reading this description, may suggest to those skilled in the art without departing from the spirit of the present invention and/or scope of the attached claims.

### EXAMPLES

### Example 1: Preparation of the Wet Crystalline Paste of Starch

Two procedures were carried out: with and without potassium sorbate (K-sorb). An aqueous starch solution was prepared consisting of a mixture of 100 grams of starch and 1900 grams of distilled water, so as to have a ratio of 5:95 (starch:water). Other ratios were carried out, for example 10:90 to 1:99. The distilled water was previously acidified to bring it to pH=4.5.

The aqueous solution was stirred using a magnetic stirrer at various constant speeds between 100 rpm and 300 rpm for about 45 minutes. Heating was then started from room temperature to 50° C., maintaining constant stirring, and using heating ramps of around 1° C./min. Then, it was left stirring at the same speed and at 50° C. for around 10 minutes. In this stage, the amylose proceeds to detach from the starch, solubilizing in the water.

Immediately afterwards, the container with the solution that was at 50° C. was placed in an ice bath to cut the heating inertia and prevent the temperature from continuing to rise, and then it was stored in a refrigerator (6° C.) for about 24 hours. hours. At that stage, phase separation occurred due to decantation of the starch. Subsequently, the supernatant was discarded and the resulting paste was washed 4 times with distilled water, in order to remove the amylose that had detached from the starch grain and that had been solubilized in the water. After each wash, an aliquot of the supernatant (10 ml) was separated to qualitatively check the removal of amylose during the heat treatment, and verify that it had been completely removed by the fourth wash.

The hydrated paste was divided and collected in Ziploc bags and kept at −16° C., until irradiated.

Potassium Sorbate Procedure:

A procedure was carried out as mentioned in the previous paragraphs but potassium sorbate (K-sorb) was added. The final concentration of K-sorb was around 0.2% by weight, much lower than the limit allowed for its use in foods by the FDA (which is 0.3% by weight).

### Example 2: Irradiation and End of Process for Both Wet Pastes

The irradiation of the wet pastes, which comprised an approximate ratio of 50/50 starch/water, was carried out at the Semi-Industrial Irradiation Plant (Pisi) belonging to the Ezeiza Atomic Center, Atomic Energy Commission. For this, a minimum dose of 20 KGy and a maximum dose of 23 KGy were used, with a rate of (14±1) KGy/h, according to the data reported by the company. After this process, the pastes were freeze-dried for 24 hours.

The yield of the procedure was about 74%.

### Example 3: Evaluation of Amylose Content

To do this, aliquots of the supernatants were taken and complexed with a 2% iodine solution (amylose-water-2% iodine) to generate an iodine-amylose complex. Each solution was photographed.

### Example 4: Evaluation of the Amylose Content of the Pastes Obtained at the End of the Process

100 mg of paste was weighed and 1 ml of 95% ethanol and 9 ml of 1 N NaOH were added. The system was left at room temperature for 18-24 hours. The content was transferred by washing to a 100 ml volumetric flask. Next, a 5:100 dilution of the previous system was made, adding 1 ml of 1 N acetic acid and 2 ml of 2% iodine stock solution. It was shaken and allowed to stand for 20 minutes.

### Example 5: Food Coating Process, for Example Apples with the Gels of the Invention

The nano-microparticle gel of the invention was allowed to cool at room temperature on the counter until it reached 25° C. The application of the gel at room temperature was carried out using two techniques: immersion or spray. For both cases, the food product was previously washed and dried at room temperature and controlled humidity (RH ˜56.7%).

In the case of immersion, the food was immersed in the gel for 5 to 15 seconds depending on the roughness of the product to be coated. The longest time was used in those foods whose shape was more irregular and that required a uniform and thick coverage. After removing the food, the excess gel was allowed to drain.

In the case of the spray, the gel was placed in a sprayer and sprayed on the products until completely covering their surface.

### Example 6

The release experiment of different components was carried out. In particular, it was evaluated using limonene essential oil, a commercial fertilizer (with nitrogen, potassium and phosphorus), and a commercial antibiotic (gentamicin). In all cases, the tests were carried out at room temperature on 10 samples. The desired component was injected into the gelled and lyophilized material of FIG. 13 until saturation, and the percentage of release was determined at different exposure times.

### Example 7a: Release of Essential Oils

In the case of limonene essential oil, it was observed that the product immediately releases a significant amount of essential oil, with the release after 15 min of exposure being between 30% and 40%, and after 48 hours of study, greater than 50%.

### Example 7b: Release of Commercial Fertilizer

In the case of the commercial fertilizer, the gelled and lyophilized material released between 25% and 45% at 15 min, and after 48 hours of study, the release was greater than 65%.

### Example 7c: Release of Commercial Antibiotic

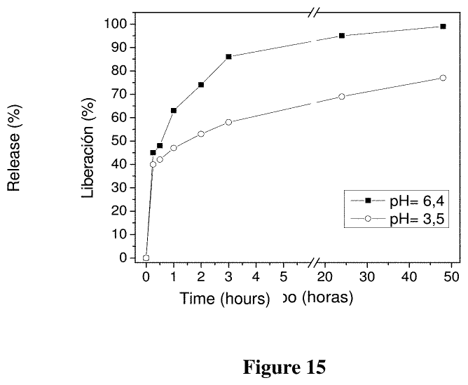

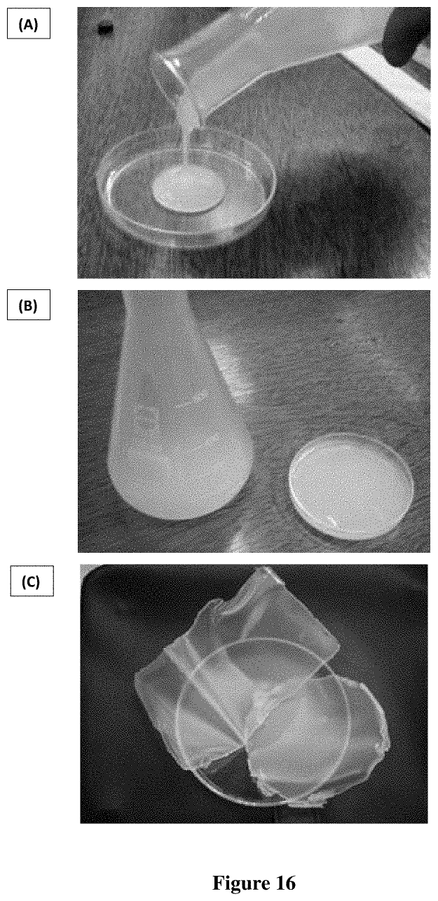

In the case of the antibiotic, the tests were carried out in different aqueous media, distilled water (pH=6.4) and acidified medium (pH=3.5), in order to simulate the pH of the stomach. FIG. 15 shows an example of an antibiotic release curve as a function of time. In all cases, after 48 hours, the release was greater than 60%. In particular, in the case of antibiotic release in a medium at pH=6.4, it was observed that it was greater than 80%, and in the case of release in an acidified medium (pH=3.5), it was observed that it was between 60% and 80%.

### Example 8a: Process for Obtaining Gel Film

The nano-microparticle gel films can be obtained by dehydration at room temperature and pressure (0.1 MPa and 25° C.) inside a hood. The dehydration procedure can also be carried out in a desiccator with a drying agent, such as silica gel, calcined anhydrous calcium sulfate, anhydrous copper sulfate or anhydrous magnesium sulfate, at room temperature (25° C.). A vacuum can be applied to the desiccator with a vacuum pump (for example of the order of 40 kPa or less) thereby speeding up the dehydration time, reducing it significantly depending on the physicochemical conditions that are set.

### Example 8b: Process for Obtaining Gel Film

From the nano-microparticle gel of the invention, with and without K-sorb, films can also be prepared by dehydration on a heating plate under pressure. To this end, nano-microparticle gel is poured into a heated press container that can increase its temperature from 50 to 150° C., which allows the gel to dehydrate. Once a consistent texture of the gel is achieved, a pressure of the order of 3.2 to 3.8 Pa is applied to the film being formed to level its thickness until it is consistent and homogeneous. The film is then cooled to room temperature (25° C.).

Once the gel adopts the consistency of a firm and homogeneous film, it is demolded. The thickness of the film will depend on the conditions imposed to obtain it, wherein said thickness is between 0.5 and 2 mm.

1. A product of crystalline starch nano-microparticles, characterized in that it comprises between 60% and 70% of crystalline nano-microparticles and between 40% and 30% of modified starch grains.

2. The product according to claim 1, characterized in that at least 90% of the nano-microparticles have sizes less than 200 nm.

3. The product according to claim 2, characterized in that more than 40% are less than 100 nm.

4. A procedure for obtaining the product of claim 1, characterized in that it comprises the following steps:
a. preparing an aqueous solution of starch:water at a ratio between 1:99 and 10:90 and stirring;
b. heating between 50° C. and 60° C. maintaining constant agitation;
c. cooling the solution to 4-6° C.;
d. washing the solution with distilled water until a wet paste is obtained;
e. irradiating the wet paste at a dose between 20 kGy and 23 kGy;
f. lyophilizing.

5. The procedure according to claim 4, characterized in that the water of step a. has a pH of 4.5.

6. The procedure according to claim 4, characterized in that the heating ramp of step b. is 1°/min.

7. The procedure according to claim 4, characterized in that the wet paste of step d. comprises a starch/water ratio of 50/50.

8. The procedure according to claim 4, characterized in that the irradiation rate is 14±1 KGy/h.

9. A starch gel characterized in that it comprises between 1% and 20% of the product of claim 1 and between 99% and 80% of water.

10. A method for coating food using the starch gel of claim 9.

11. A method for preparing cosmetic creams using the starch gel of claim 9.

12. A method for preparing a compound for controlled release of agents selected from the group consisting of antibiotics, fertilizers and essential oils using the starch gel of claim 9.

13. A procedure for obtaining the starch gel of claim 9, characterized in that it comprises the following steps:
a. dissolving between 1% and 20% of the lyophilized product in boiling water; and
b. arranging at room temperature for at least 30 minutes.

14. A procedure for obtaining nano-microparticle gel films characterized in that it comprises:
a. pouring the nano-microparticle gel of claim 9 into a container;
b. allowing the gel to dehydrate at room temperature and pressure (0.1 MPa and 25° C.) until a consistent and homogeneous film is achieved; and
c. demolding the formed film.

15. The procedure of claim 14, characterized in that the dehydration is carried out in a desiccator with a drying agent at room temperature (25° C.).

16. The procedure of claim 14, characterized in that a vacuum of 40 kPa or less is applied to the desiccator with a vacuum pump.

17. The procedure of claim 14, characterized in that the drying agent is selected from silica gel, calcined anhydrous calcium sulfate, anhydrous copper sulfate and anhydrous magnesium sulfate.

18. A procedure for obtaining nano-microparticle gel films characterized in that it comprises:
a. pouring the nano-microparticle gel of claim 9 into a container capable of being heated by a press;
b. allowing the gel to dehydrate at room temperature and pressure (0.1 MPa and 25° C.) while increasing the temperature of the press vessel to a temperature of 50° C. to 150° C.;
c. once a consistent texture of the gel is achieved, a pressure of 3.2 Pa to 3.8 Pa is applied on the forming film, until a consistent and homogeneous film is achieved;
d. cooling the film to room temperature (25° C.); and
e. demolding the formed film.

19. The procedure of claim 14, characterized in that the thickness of the film is between 0.5 mm and 2 mm.

20. The procedure of claim 14, characterized in that the nano-microparticle gel film comprises K-sorb.
